(19) United States
(12) Patent Application Publication
(10) Pub. No.: US 2025/0068854 A1
(43) Pub. Date: Feb. 27, 2025

(54) ELECTRONIC DEVICE FOR GENERATING EVENT ON BASIS OF CONVERSATION CONTENT, CONTROL METHOD, AND NON-TRANSITORY COMPUTER-READABLE STORAGE MEDIUM

(71) Applicant: SAMSUNG ELECTRONICS CO., LTD., Suwon-si (KR)

(72) Inventors: Hyungtak CHOI, Suwon-si (KR); Hyeonmok KO, Suwon-si (KR); Sangjun JEON, Suwon-si (KR)

(73) Assignee: SAMSUNG ELECTRONICS CO., LTD., Suwon-si (KR)

(21) Appl. No.: 18/942,046

(22) Filed: Nov. 8, 2024

Related U.S. Application Data
(63) Continuation of application No. PCT/KR2023/004031, filed on Mar. 27, 2023.

(30) Foreign Application Priority Data
May 9, 2022 (KR) 10-2022-0056839
Jun. 24, 2022 (KR) 10-2022-0077846

(51) Int. Cl. G06F 40/35

(52) U.S. Cl. CPC G06F 40/35

(57) ABSTRACT

A control method of an electronic device for generating an event including: obtaining, in real-time, participants from a conversation content and the conversation content of the participants; and generating an event including at least one slot from the obtained conversation content using a trained event generating artificial intelligence model, where the generating the event includes: identifying the participants and history information regarding slot contents from a dialogue history of the participants; applying weight values to each of the slot contents expressed by each identified participant based on at least one among confirm or reject information, additional information, and history information of other participants regarding respective slot contents expressed by each participant identified from the obtained conversation content; and determining a slot content agreed to by participants, or a slot content having at least a pre-set weight as a final slot content of the at least one slot of the event.

### CROSS-REFERENCE TO RELATED APPLICATION(S)

This application is a continuation of International Application No. PCT/KR2023/004031, filed on Mar. 27, 2023, in the Korean Intellectual Property Receiving Office, which is based on and claims priority to Korean Patent Applications No. 10-2022-0056839, filed on May 9, 2022 and No. 10-2022-0077846, filed on Jun. 24, 2022, in the Korean Intellectual Property Office, the disclosures of which are incorporated by reference herein in their entireties.

### BACKGROUND

### 1. Field

The disclosure relates to an electronic device for generating an event based on conversation content, a control method, and a non-transitory computer-readable storage medium.

### 2. Description of Related Art

Electronic apparatuses may execute a dialogue application and display conversation content input by a user of an electronic device and conversation content of another user received from another electronic device in a dialogue application window in a temporal order. The conversation content may include texts, images, emoticons, and the like input by a dialogue participant using the same dialogue application.

### SUMMARY

Aspects of the present disclosure will be set forth in part in the description which follows and, in part, will be apparent from the description, or may be learned by practice of the presented embodiments.

According to an aspect of the disclosure, provided is a control method of an electronic device for generating an event, the method may include: obtaining, in real-time, participants from a conversation content and the conversation content of the participants; and generating an event including at least one slot from the obtained conversation content using a trained event generating artificial intelligence model, where the generating the event includes: identifying the participants and history information regarding slot contents from a dialogue history of the participants; applying weight values to each of the slot contents expressed by each identified participant based on at least one among confirm or reject information, additional information, and history information of other participants regarding respective slot contents expressed by each participant identified from the obtained conversation content; determining a slot content agreed by a pre-set number of participants, or a slot content having at least a pre-set weight value as a final slot content of the at least one slot of the event; and generating the event by setting candidate slot contents, being at least some of the slot contents expressed by each identified participant, in slots with no final slot content based on the applied weight values.

The applying the weight values to the slot contents may include: identifying a decision maker among the participants based on the history information, and applying a positive weight value to a slot content agreed by the identified decision maker.

The applying the weight values to the slot contents may include: applying a positive weight value corresponding to a number of positive responses of the other participants to the slot contents expressed by each identified participant, and applying a negative weight value corresponding to a number of negative responses of the other participants to the slot contents expressed by each identified participant.

The applying the weight values to the slot contents may include: applying, based on an event included in the dialogue history being similar to a current event, a weight value to a slot content which is similar to a slot content of the event included in the dialogue history.

The at least one slot may include at least one among a time or a location.

The applying the weight values to the slot contents may include: applying, based on the at least one slot being a time slot, a positive weight value to a slot content of a future time closest with a current time.

The applying the weight values to the slot contents may include: applying, based on the at least one slot being a location slot, a weight value to a slot content of the location slot based on at least one among a frequency of positivity regarding a slot content of a location based on the history information, a frequency of negativity regarding a slot content of a location based on the history information, whether the location is a registered location, or a distance with a current position.

The method may further include: outputting the generated event information including at least one among the final slot content and the candidate slot contents.

The outputting the event information may include: outputting the candidate slot contents from a candidate slot content with a highest weight value according to weight value information of the candidate slot contents in a descending order.

According to an aspect of the disclosure, an electronic device may include: an input interface; a communication interface; a memory storing instructions; and at least one processor configured to execute the instructions, where, by executing the instructions, the at least one processor is configured to: obtain, in real-time, participants from a conversation content and the conversation content of the participants through the input interface and the communication interface, and generate an event comprising at least one slot from the obtained conversation content using a trained event generating artificial intelligence model, and where the at least one processor is configured to: identify the participants and history information regarding slot contents from a dialogue history of the participants stored in the memory, apply weight values to each of the slot contents expressed by each identified participant based on at least one among confirm or reject information, additional information, and history information of other participants regarding each of the slot contents expressed by each participant identified from the obtained conversation content, determine a slot content agreed by a pre-set number of participants, or a slot content having at least a pre-set weight value as a final slot content of the at least one slot of the event, and generate the event by setting candidate slot contents, being at least some of the slot contents expressed by each identified participant, in slots with no final slot content based on the applied weight values.

The at least one processor may be further configured to: identify a decision maker among the participants based on the history information using the trained event generating artificial intelligence model, and apply a positive weight value to a slot content agreed by the identified decision maker.

The at least one processor may be further configured to: apply a positive weight value corresponding to a number of positive responses of the other participants to the slot contents expressed by each identified participant using the trained event generating artificial intelligence model, and apply a negative weight value corresponding to a number of negative responses of the other participants to the slot contents expressed by each identified participant.

The at least one processor may be further configured to: apply, based on an event comprised in the dialogue history being identified as similar to a current event by using the trained event generating artificial intelligence model, a weight value to a slot content which is similar to the slot content of the event comprised in the dialogue history.

The at least one slot may include at least one among a time or a location.

The at least one processor may be further configured to: apply, based on the at least one slot being identified as a time slot by using the trained event generating artificial intelligence model, a positive weight value to a slot content of a future time closest with a current time.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram illustrating a configuration of an electronic device according to an embodiment of the disclosure;

FIG. 2 is a block diagram illustrating a detailed configuration of an electronic device according to an embodiment of the disclosure;

FIG. 3 is a diagram illustrating a configuration of a processor according to an embodiment of the disclosure;

FIG. 4, FIG. 5, and FIG. 6 are diagrams illustrating embodiments of generating an event from conversation content according to one or more embodiments of the disclosure;

FIG. 7 is a flowchart illustrating a control method of an electronic device according to an embodiment of the disclosure; and

FIG. 8 is a flowchart illustrating a detailed process of generating an event according to an embodiment of the disclosure.

### DETAILED DESCRIPTION

Various embodiments will be described in greater detail below with reference to the accompanied drawings. Embodiments described herein may be variously modified. A specific embodiment may be illustrated in the drawings and described in detail in the detailed description. However, the specific embodiment described in the accompanied drawing is only to assist in the easy comprehension of the various embodiments. Accordingly, it should be noted that the technical spirit described herein is not limited by the specific embodiments described in the accompanied drawings, and should be interpreted to include all modifications, combinations, equivalents and/or alternatives of the embodiments included in the spirit of the disclosure and in the technical scope.

Terms including ordinal numbers such as first and second may be used in describing various elements, but the elements are not limited by the above-described terms. The above-described terms may be used only for the purpose of distinguishing one element from another element.

In the disclosure, terms such as “include,” “have,” “comprise” or the like are used herein to designate a presence of a characteristic, number, step, operation, element, component, or a combination thereof, and not to preclude a presence or a possibility of adding one or more of other characteristics, numbers, steps, operations, elements, components or a combination thereof. When a certain element is indicated as being “coupled with/to” or “connected to” another element, it may be understood as the certain element being directly coupled with/to the another element or as being coupled through other element. On the other hand, when the certain element is indicated as “directly coupled with/to” or “directly connected to” the another element, it may be understood as the other element not being present therebetween.

Meanwhile, the term “module” or “part” for elements used in the disclosure perform at least one function or operation. Further, the term “module” or “part” may perform a function or operation implemented with a hardware or software, or implemented with a combination of hardware and software. In addition, a plurality of “modules” or a plurality of “parts,” except for a “module” or a “part” which needs to be performed in a specific hardware or performed in at least one processor, may be integrated in at least one module. A singular expression includes a plural expression, unless otherwise specified.

In describing the disclosure, an order of each step is to be understood as non-limiting unless the order of each step needs to be performed such that a preceding step must be performed logically and temporally prior to a following step. That is, except for exceptional cases as described above, even if a process described as the following step is performed preceding a process described as the preceding step, it does not influence the nature of the disclosure and the scope of protection should also be defined regardless of the order of the step. Further, in the disclosure, expressions such as “A or B” not only refers to any one of A and B selectively, but also may be defined as including both A and B.

Further, the disclosure is not to be construed in an exclusive sense including only the recited elements, but is to be interpreted in a non-exclusive sense where other elements may be included.

In addition thereto, in describing the disclosure, in case it is determined that the detailed description of related known technologies or configurations may unnecessarily confuse the gist of the disclosure, the detailed description thereof will be omitted. Meanwhile, each embodiment may be independently implemented or operated, but each embodiment may also be implemented or operated in combination thereof.

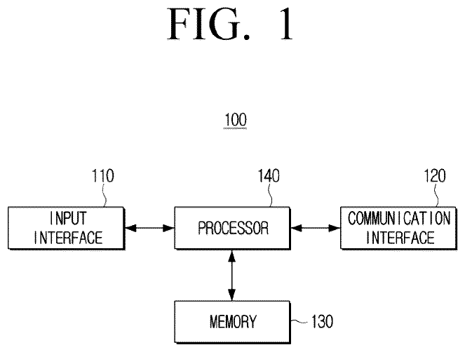

FIG. 1 is a block diagram illustrating a configuration of an electronic device according to an embodiment of the disclosure.

Referring to FIG. 1, an electronic device 100 may include an input interface 110, a communication interface 120, a memory 130, and a processor 140. The electronic device 100 may execute a dialogue application.

The input interface 110 may receive content (conversation content) from a user of the electronic device 100. For example, content may include texts, images, emoticons, and the like. The processor 140 may display input content in a window of the dialogue application. In addition, the input interface 110 may receive a control command and the like from the user. For example, the input interface 110 may include a keyboard, a button, a key pad, a touch pad, a touch screen, and the like. The input interface 110 may be referred to as an input device, an inputter, an input module, or the like.

The communication interface 120 may perform communication with an external device. The communication interface 120 may receive content (conversation content) input from the external device, and transmit content input from the electronic device 100 to the external device. The processor 140 may display the content received from the external device in the window of the dialogue application. For example, the communication interface 120 may perform communication with the external device through at least one communication method from among Wi-Fi, Wi-Fi direct, Bluetooth, ZigBee, 3rd Generation (3G), 3rd Generation Partnership Project (3GPP), and long term evolution (LTE) communication methods. The communication interface 120 may be referred to as a communication device, a communicating part, a communication module, a transceiver, and the like.

The memory 130 may store a previous dialogue history, and store content of a current dialogue application. Further, the memory 130 may store data, algorithms and the like which perform a function of the electronic device 100, and store programs, instructions, and the like which are operated in the electronic device 100. For example, the memory 130 may store a trained event generating artificial intelligence model. The algorithms, data, and the like stored in the memory 130 may be loaded in the processor 140 by control of the processor 140 and used in performing a data processing process. That is, the event generating artificial intelligence model that performed the training stored in the memory 130 maybe loaded to the processor 140 and generate an event from the conversation content. For example, the memory 130 may be implemented into types such as, for example, and without limitation, a ROM, a RAM, a HDD, a SSD, a memory card, and the like. The event may be a schedule to be performed in the future by participants. For example, the event may include a meeting, a conference, an appointment, a workshop, an athletics competition, a trip, or the like.

The processor 140 may control each configuration of the electronic device 100. The processor 140 may control the input interface 110 to receive the conversation content from the user, and control the communication interface 120 to receive the conversation content from the external device. In addition, the processor 140 may load the trained event generating artificial intelligence model and the previous dialogue history from the memory 130, and store a current conversation content in the memory 130.

The processor 140 may obtain, in real-time, the input conversation content, dialogue participants from the received conversation content, and content of the dialogue participant. The processor 140 may identify whether the conversation content is continued using a context of the conversation content and participant information. The processor 140 may determine a number of participants using the participant information, and manage the obtained content by each participant. For example, if a first participant (a user of an electronic device), a second participant, and a third participant are in a dialogue, the processor 140 may separately generate databases of the first participant to the third participant, and store the conversation content of each participant in the corresponding database of each participant. Because the processor 140 manages the conversation content of each participant separately, the processor 140 may easily identify dialogue content of each participant.

The processor 140 may generate an event from the obtained conversation content using the trained event generating artificial intelligence model. The function associated with artificial intelligence according to the disclosure may be operated through the processor 140 and the memory 130. The processor 140 may be configured with one or a plurality of processors 140. At this time, the one or plurality of processors 140 may be a generic-purpose processor such as a CPU, an AP, or a digital signal processor (DSP), a graphics dedicated processor such as a GPU or a vision processing unit (VPU), or an artificial intelligence dedicated processor such as an NPU. The one or plurality of processors 140 may control to process input data according to a pre-defined operation rule or an artificial intelligence model stored in the memory 130. Alternatively, if the one or plurality of processors 140 is the artificial intelligence dedicated processor, the artificial intelligence dedicated processor may be designed to a hardware structure specialized in processing a specific artificial intelligence model.

A pre-defined operation rule or an artificial intelligence model is characterized by being created through learning. Here, the being created through learning refers to the pre-defined operation rule or artificial intelligence model set to perform a desired feature (or, purpose) being created as a basic artificial intelligence model is trained by a learning algorithm using a plurality of training data. The learning may be carried out in a device itself in which the artificial intelligence according to the disclosure is performed, or carried out through a separate server and/or system. Examples of the learning algorithm may include a supervised learning, an unsupervised learning, a semi-supervised learning, or a reinforcement learning, but is not limited to the above-described examples.

The artificial intelligence model may be formed of a plurality of neural network layers. Each of the plurality of neural network layers may have a plurality of weight values, and perform a neural network operation through an operation between an operation result of a previous layer and the plurality of weight values. The plurality of weight values included in the plurality of neural network layers may be optimized by a learning result of the artificial intelligence model. For example, the plurality of weight values may be updated for a loss value or a cost value obtained from the artificial intelligence model during a learning process to be reduced or minimized. The artificial neural network may include a Deep Neural Network (DNN), and examples thereof may include a Convolutional Neural Network (CNN), a Deep Neural Network (DNN), a Recurrent Neural Network (RNN), a Restricted Boltzmann Machine (RBM), a Deep Belief Network (DBN), a Bidirectional Recurrent Deep Neural Network (BRDNN), a Deep Q-Networks, or the like, but the embodiment is not limited thereto.

The processor 140 may identify participants and history information regarding a previous slot content from the previous dialogue history of the participants using the trained event generating artificial intelligence model. A slot may be an item included in an event, and a slot content may be a specific value corresponding to the slot. In an embodiment, if the event is a meeting, the slot may be time, a location, and the like. Further, the slot content of a time slot may be July 21st, July 22nd, July 23rd, and the like, and the slot content of a location slot may be a main meeting room, meeting room A, a cafe, and the like. The time slot may include a month slot, a day slot, a morning/afternoon slot, a during day time slot, and the like. In addition, the slot may include a means of transportation, a type, things to prepare, time required, cost, and the like according to the event. The processor 140 may identify history information regarding the participants from the previous dialogue history. For example, the processor 140 may identify a participant who made the final decision on an event from the previous dialogue history as a decision maker. Alternatively, the processor 140 may identify a participant included in many events. In addition, the processor 140 may identify a slot content included in the previous dialogue history.

The processor 140 may identify confirm or reject information, additional information, and the like of the participants from the conversation content. For example, the additional information may include co-reference resolution information, and the like. The co-reference resolution information may be a same content as a previously displayed content from the conversation content and may mean information differently expressed from the previous expression. For example, if participant A expressed “do you have time on the 25th?” and participant B expressed “that day is difficult for me.”, information identifying “that day” expressed by participant B as the 25th may be the co-reference resolution information. The co-reference resolution information may be obtained from a context of the conversation content. The processor 140 may identify the slot contents expressed by each participant based on confirm or reject information, additional information, history information, and the like and apply weight values to the identified slot contents using the trained event generating artificial intelligence model.

For example, the processor 140 may identify the decision maker from among the participants based on history information, and add a positive weight value to the slot content agreed by the identified decision maker. Alternatively, the processor 140 may add a negative weight value to the slot content disagreed by the identified decision maker. The weight value added to the slot content agreed or disagreed by the identified decision maker may be a greater value than another weight value.

Alternatively, the processor 140 may apply additional positive weight values corresponding to a number of positive responses of the participants regarding the slot content to the slot content, and apply additional negative weight values corresponding to a number of negative responses of the participants regarding the slot content to the slot content. In an embodiment, the processor 140 may apply a weight value of 1 to the slot content agreed by one person, and apply a weight value of 3 to the slot content agreed by three people. Alternatively, the processor 140 may apply a weight value of −2 to the slot content rejected by one person, and apply a weight content of −4 to the slot content rejected by three people.

Alternatively, the processor 140 may apply, based on an event included in the previous dialogue history being the same as a current event, a weight value to a slot content which is the same as the slot content of the event included in the previous dialogue history. The processor 140 may apply a positive weight value if the slot content of the event included in the previous dialogue history is a slot content to which a previous participant showed a positive reaction, and apply a negative weight value if it is a slot content which the previous participant showed a negative reaction.

Alternatively, if the slot is a time slot, the processor 140 may apply an additional positive weight value to a slot content of a future time which is closest with a current time. For example, the processor 140 may apply different weight values to slot contents of a plurality of time slots in a descending order from the slot contents close to the current time.

Alternatively, if the slot is a location slot, the processor 140 may apply a weight value to a slot content of the location slot based on a frequency of positivity regarding the slot content of the location based on history information, a frequency of negativity regarding the slot content of the location based on history information, whether it is a registered location, a distance with a current position, or the like. According to an embodiment, the processor 140 may apply different positive weight values according to the frequency of positivity, and apply different negative weight values according to the frequency of negativity. The processor 140 may apply the positive weight value if the slot content is a registered location. The processor 140 may apply different weight values to slot contents of a plurality of location slots in a descending order from the slot contents close to the current position.

The processor 140 may determine a slot content agreed by participants of a pre-set number or a slot content of greater than or equal to a pre-set weight value as a final slot content of the corresponding slot. The processor 140 may generate an event by setting the determined final slot content as a slot content of the slot. Conversely, the processor 140 may not decide the final slot content. In this case, the processor 140 may generate an event by setting a plurality of candidate slot contents as the slot content of the slot. The processor 140 may arrange, based on not deciding the final slot content, the plurality of candidate slot contents in a descending order based on the applied weight values.

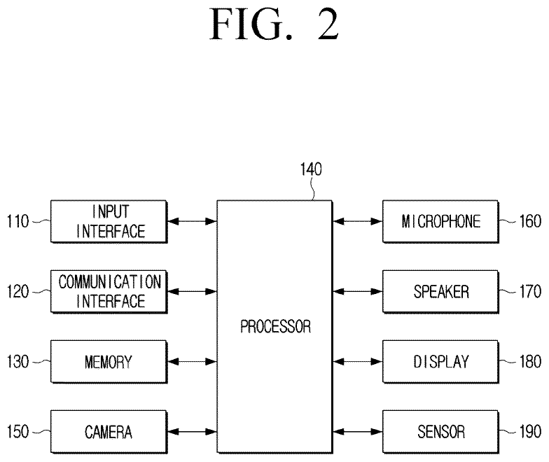

FIG. 2 is a block diagram illustrating a detailed configuration of an electronic device according to an embodiment of the disclosure.

Referring to FIG. 2, the electronic device 100 may include the input interface 110, the communication interface 120, the memory 130, the processor 140, a camera 150, a microphone 160, a speaker 170, a display 180, and a sensor 190. Because the input interface 110, the communication interface 120, and the memory 130 are the same as that described in FIG. 1, detailed descriptions thereof will be omitted.

The camera 150 may capture a surrounding environment of the electronic device 100. Alternatively, the camera 150 may capture an expression of the user, a motion, a gaze of the user, and the like. The processor 140 may recognize a control command or reading/viewing area based on the captured expression of the user, the captured motion, the captured gaze of the user, and the like, and perform a control operation corresponding to the recognized control command or the recognized area. For example, the camera 150 may include a CCD sensor and a CMOS sensor. In addition, the camera 150 may include an RGB camera or a depth camera.

The microphone 160 may receive a voice of the user. The processor 140 may recognize a control command based on the input voice, and perform a control operation corresponding to the recognized control command.

The speaker 170 may output a sound signal performed with sound signal processing. For example, the speaker 170 may output a notification regarding whether the conversation content is received from the electronic device 100 in a notification sound or voice. Alternatively, the speaker 170 may output the generated event information in voice. In addition, the speaker 170 may output an input command of the user, information on a state of the electronic device 100, information associated with an operation, or the like in voice or a notification sound.

The display 180 may display information in a visual method. For example, the display 180 may display the conversation content on the dialogue application, and display the generated event information. For example, the display 180 may be implemented as a liquid crystal display (LCD), an organic light emitting diode (OLED), a touch screen, and the like. If the display 180 is implemented with a touch screen, the electronic device 100 may receive a control command through the touch screen.

The sensor 190 may sense information associated with the user or the surrounding environment. The processor 140 may perform a control operation based on the sensed information. For example, the sensor 190 may include at least one among an image sensor, a tracking sensor, an angle sensor, an acceleration sensor, a gravity sensor, a gyro sensor, a geomagnetic sensor, a direction sensor, a motion recognition sensor, a proximity sensor, a voltmeter, an ammeter, a barometer, a hygrometer, a thermometer, an illuminance sensor, a heat detection sensor, a touch sensor, an infrared sensor, an ultrasonic sensor, and the like.

The electronic device 100 may include all the above-described configurations, or include a portion of the configurations. In addition, the electronic device 100 may further include other configurations that perform various functions in addition to the above-described configurations.

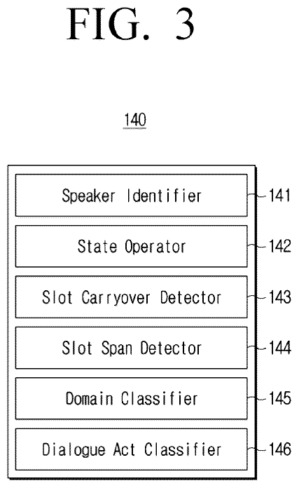

FIG. 3 is a diagram illustrating a configuration of a processor according to an embodiment of the disclosure.

The processor 140 may include a speaker (participant) identifier 141, a state operator 142, a slot carryover detector 143, a slot span detector 144, a domain classifier 145, a dialogue act classifier 146, and the like. The configurations shown in FIG. 3 may identify slot contents from a current sentence of each participant, and decide on whether to add or delete.

The speaker (participant) identifier 141 may identify participants that participated in a dialogue. For example, if participant A expressed “how is the 25th for the product development meeting date?”, the speaker identifier 141 may identify that the above is a sentence expressed by participant A.

The state operator 142 may determine whether to add or delete slot contents. In the above-described example, the state operator 142 may add the 25th to a date slot if the 25th expressed by participant A is a new date. Alternatively, if the 25th expressed by participant A is a previously expressed date, the state operator 142 may not add the 25th expressed by participant A to the date slot and delete (ignore) the date.

The slot carryover detector 143 may decide on whether to maintain the existing slot content. In the above-described example, the date slot may include the 23rd, the 25th, and the 27th. If the slot carryover detector 143 determines that the 25th expressed by participant A is also a candidate date, the existing 23rd and 27th may be maintained. Alternatively, if the expression by participant A is an agreement regarding the previously expressed 25th or if participant A is the decision maker, the state operator 142 may delete the 23rd and 27th included in the date slot.

The slot span detector 144 may determine an extraction position of the slot content. In the above-described example, the slot span detector 144 may determine an area of the 25th in the sentence “how is the 25th for the product development meeting date?” expressed by participant A as an area extracted as the slot content. In addition, the slot span detector 144 may determine a start area and an end area of a sentence.

The domain classifier 145 may identify a domain of a slot. For example, the slot may be an item such as, time, location, means of transportation, type, things to prepare, time required, cost, and the like including a year, a day, a month, time during the day, morning or afternoon, and the like associated with an event. The domain may mean each slot or a category of the slot content included in each slot. That is, the 25th, the 26th, the 27th, and the like included in the conversation content may be slot content corresponding to the time slot or the day slot, and may be classified into a time domain or a day domain.

The dialogue act classifier 146 may identify whether there is an agreement/positivity or a disagreement/negativity regarding the slot content. For example, participant A may express “how is the 25th for the product development meeting date?”. If participant B expresses “good.”, the dialogue act classifier 146 may identify the text expressed by participant B as an agreement intent regarding the 25th. Alternatively, if participant B expresses “I have another schedule.”, the dialogue act classifier 146 may identify the text expressed by participant B as a disagreement intent regarding the 25th.

Each configuration shown in FIG. 3 may be implemented with hardware, and implemented also with software. If each configuration shown in FIG. 3 is implemented with software, each configuration may perform a function by being loaded in the processor 140 according to control by the processor 140. In addition, each configuration may be included in the trained event generating artificial intelligence model.

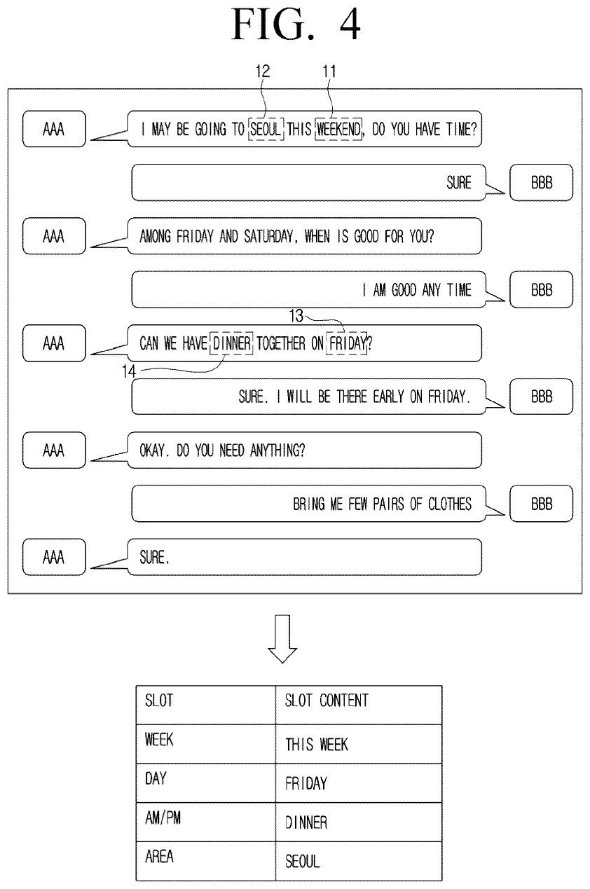

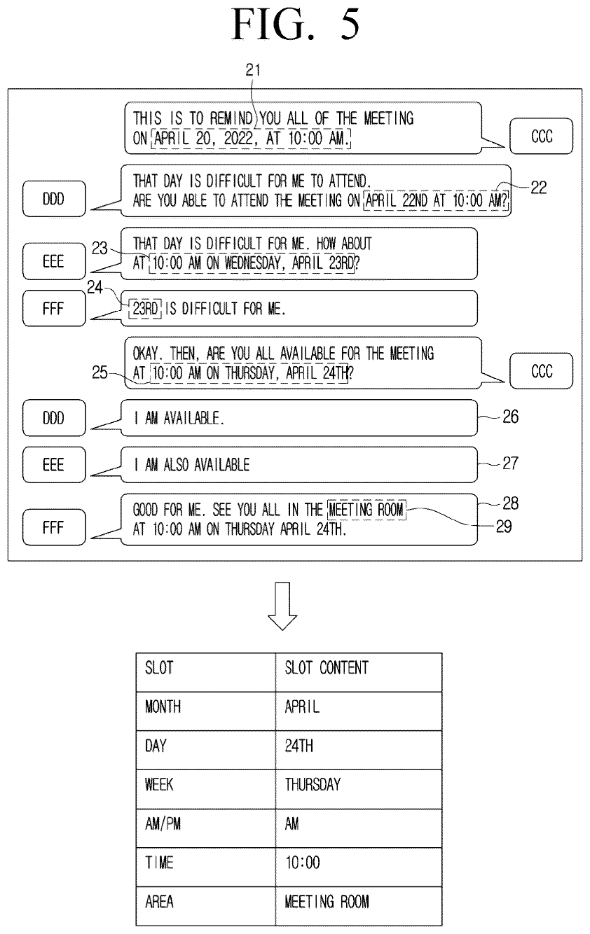

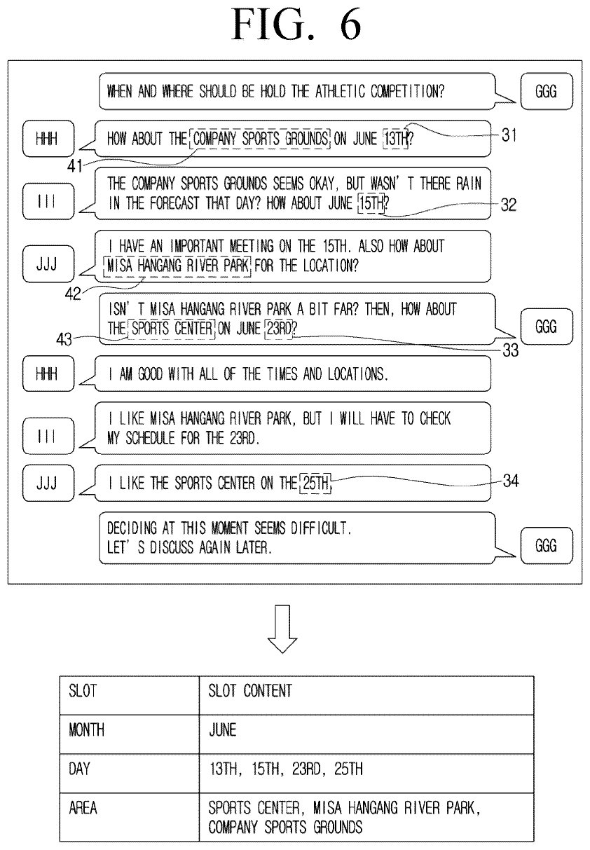

FIG. 4 to FIG. 6 are diagrams illustrating embodiments of generating an event from conversation content.

Referring to FIG. 4 to FIG. 6, screens of the dialogue application including conversation content and events generated from the conversation content are shown.

Referring to FIG. 4, if AAA expresses “I may be going to Seoul this weekend, do you have time?”, the electronic device 100 may identify the speaker as AAA and the conversation content expressed by AAA. The electronic device 100 may generate a database regarding AAA and store the conversation content expressed by AAA. Further, the electronic device 100 may determine the start area and the end area of the conversation content expressed by AAA, and extract weekend 11 and Seoul 12 which correspond to the slot contents. The electronic device 100 may determine the extracted weekend 11 as the day domain (or, a time domain, a day of a week domain), and determine Seoul 12 as the location domain. The electronic device 100 may identify the weekend 11 as a slot content of the day slot based on the determined domain, and identify Seoul 12 as the slot content of the location slot. Alternatively, the electronic device 100 may determine the week (or, day of the week) domain and the day domain from “this weekend”, and identify a slot content of a week slot or the day slot. The electronic device 100 may generate a slot of an event because it is a slot content first expressed in the conversation content, and add a slot content.

The electronic device 100 may identify, from a conversation content of “sure” of BBB, an agreement intent of BBB regarding the weekend 11 and Seoul 12. In addition, the electronic device 100 may apply positive weight values to the slot contents of the weekend 11 and Seoul 12 agreed to by BBB.

The electronic device 100 may extract Friday 13 and dinner 14 from a conversation content of “can we have dinner together on Friday?” expressed by AAA, and identify Friday 13 as a slot content of the day slot, and dinner 14 as the slot content of the morning/afternoon slot. Because Friday 13 is a newly proposed slot content as a slot content of the day slot, the electronic device 100 may add Friday 13 as the slot content of the day slot. In addition, because dinner 14 is a new slot content of a morning/afternoon slot, the electronic device 100 may generate a morning/afternoon slot and add dinner 14 as the slot content of the morning/afternoon slot.

The electronic device 100 may identify, from a conversation content of “Sure. I will be there early on Friday.” of BBB, an agreement intent of BBB regarding Friday 13 and dinner 14. In addition, the electronic device 100 may apply positive weight values to the slot contents of Friday 13 and dinner 14 agreed to by BBB. The electronic device 100 may determine whether to delete the weekend 11 which was previously added to the day slot or delete Friday 13 which was newly expressed as the slot content of the day slot. The electronic device 100 may apply additional weight value to Friday 13 which was lastly expressed because BBB agreed to both the weekend 11 and Friday 13. The electronic device 100 may delete the weekend 11 from the day slot, and determine Friday 13 as the final slot content of the day slot. The electronic device 100 may generate an event including the slot content of this week in the week slot, Friday in the day slot, dinner in the morning/afternoon slot, and Seoul in the location slot, and output the generated event using a display. Alternatively, the electronic device 100 may add the generated event as a new schedule in a calendar application. The above-described example is one embodiment, and the electronic device 100 may perform functions such as applying weight values, identifying domains, slots, and slot contents, adding and deleting slot contents, determining the final slot content, and the like using the trained event generating artificial intelligence model.

Referring to FIG. 5, an example of a conversation content in which four participants CCC, DDD, EEE, and FFF are discussing a schedule is shown.

The electronic device 100 may identify April 20th, 10:00 AM 21 as a slot content from a conversation content of “this is to remind you all of the meeting on Apr. 20, 2022, at 10:00 AM.” expressed by CCC. The electronic device 100 may identify April 20th, 10:00 AM 21 as the slot content of the time slot as a time slot content in a broad sense. Alternatively, the electronic device 100 may identify April as the slot content of the month slot, 24th as the slot content of the day slot, morning as the slot content of the morning/afternoon slot, 10:00 as the slot content of a detailed time slot.

The electronic device 100 may determine, from a conversation content of “That day is difficult for me to attend.” expressed by DDD, as a negative intent regarding the above-described slot content and apply a negative weight value to the above-described slot content. Further, the electronic device 100 may identify, from a conversation content of “Are you able to attend the meeting on April 22nd at 10:00 AM?” expressed by DDD, April 22nd 10:00 AM 22 as slot contents of each slot. Further, the electronic device 100 may add a new slot content of 22nd as a slot content of the day slot.

The electronic device 100 may determine, from a conversation content of “That day is difficult for me” expressed by EEE, as a negative intent regarding the slot content of April 22nd 10:00 AM 22 identified from the conversation content of DDD. Further, the electronic device 100 may apply a negative weight value to the slot content of April 22nd 10:00 AM 22 identified from the conversation content of DDD. Meanwhile, the electronic device 100 may identify history information from a previous dialogue history. In an embodiment, the electronic device 100 may identify EEE as the decision maker. In this case, the electronic device 100 may additionally apply a negative weight value to the slot content of April 22nd 10:00 AM 22 to which EEE expressed a negative intent. In addition, the electronic device 100 may identify, from a conversation content of “How about at 10:00 AM on Wednesday, April 23rd?” expressed by EEE, April 23rd Wednesday 10:00 AM 23 as slot contents of each slot, and add 23rd as a new slot content of the day slot. In addition, the electronic device 100 may determine Wednesday as the week domain, and identify as a slot content of the week slot. The electronic device 100 may add, because a slot content of the week slot is first identified, the week slot and add Wednesday as the slot content of the week slot. In addition, the electronic device 100 may apply, because EEE was identified as the decision maker, a positive weight value to the slot content of April 23rd Wednesday 10:00 AM 23.

The electronic device 100 may determine, from a conversation content of “23rd is difficult for me.” expressed by FFF, as a negative intent regarding the slot content of April 23rd Wednesday 10:00 AM 23, and apply a negative weight value to the slot content of April 23rd Wednesday 10:00 AM 23.

The electronic device 100 may identify, from a conversation content of “Are you all available for the meeting at 10:00 AM on Thursday, April 24th?” expressed by CCC, April 24th Thursday 10:00 AM 25 as slot contents of each slot, and add 24th in the day slot and Thursday as a new slot content of the week slot.

The electronic device 100 may determine, from a conversation content 26 of “I am available.” expressed by DDD, as an agreement intent regarding the slot content of April 24th Thursday 10:00 AM 25. Further, the electronic device 100 may apply a positive weight value to the slot content of April 24th Thursday 10:00 AM 25. In addition, the electronic device 100 may determine, from a conversation content 27 of “I am also available” expressed by EEE and a conversation content 28 of “Good for me” expressed by FFF, as an agreement intent regarding the slot content of April 24th Thursday 10:00 AM 25, and apply additional positive weight values corresponding to the number of positive responses. Alternatively, because all four people agreed in the dialogue participated by four people, the electronic device 100 may determine the slot content of April 24th Thursday 10:00 AM 25 as the final slot content. Meanwhile, the electronic device 100 may decide on the final slot content if participants of a pre-set number or greater than or equal to a pre-set ratio agreed. For example, if the pre-set number is set to two people, the electronic device 100 may decide that a slot content agreed by two people is the final slot content. Alternatively, if the pre-set ratio is set to 70%, the electronic device 100 may decide that a slot content agreed by three people from among the four participants that participated in the dialogue is the final slot content. In an embodiment, if a slot content is decided by a majority from a dialogue participated by one-hundred people, the electronic device 100 may set the pre-set ratio to 51%, and decide that the slot content agreed by fifty-one people is the final slot content.

The electronic device 100 may identify, from a conversation content 28 of “See you all at 10:00 AM on Thursday, April 24th, in the meeting room.” expressed by FFF, the meeting room 29 as a slot content of a location slot. Further, the electronic device 100 may add the location slot, and add the meeting room 29 as the slot content of the location slot. The electronic device 100 may identify April as a slot content of the month slot, 24th as a slot content of the day slot, Thursday as a slot content of the week slot, AM as a slot content of the morning/afternoon slot, 10:00 as a slot content of a detailed time slot, the meeting room as a slot content of the location slot, and generate an event including the identified final slot content. In addition, the electronic device 100 may delete, based on deciding the final slot content, a candidate slot content added prior thereto. For example, the electronic device 100 may delete the 20th, the 22nd, and the 23rd from the day slot. In addition, the electronic device 100 may delete other slot contents excluding the final slot content from other slots.

Alternatively, the electronic device 100 may apply, based on an event included in a previous dialogue history being same as a current event, a weight value to the slot content which is same as the slot content of the event included in the previous dialogue history. For example, if the slot content of the event included in the previous dialogue history is confirmed or if there are many agreeable/positive intents, the electronic device 100 may apply a positive weight value to the slot content corresponding to the current conversation content, and apply a negative weight value if the above is unconfirmed or if there are many disagreeable/negative intents. Alternatively, the electronic device 100 may exclude slot contents with unconfirmed, disagreeable/negative intents of a pre-set number or greater than or equal to a pre-set frequency from the slot contents of the current conversation content.

Referring to FIG. 6, an example of four participants GGG, HHH, III, and JJJ discussing an athletics competition schedule is shown.

Similar to the above-described example, the electronic device 100 may identify the slot content expressed by each participant and add the slot content in the corresponding slot. In addition, positive or negative weight values may be applied to each slot content based on agreeable/disagreeable intents of other participants. For example, the electronic device 100 may add June as a slot content of the month slot. The electronic device 100 may sequentially add 13th 31, 15th 32, 23rd 33, and 25th 34 as slot contents of the day slot according to a serial order of the conversation content, and sequentially add a company sports grounds 41, Misa Hangang River Park 42, a sports center 43 as slot contents of the location slot.

With respect to the slot content of the day slot, HHH indicated a positive/agreeable intent to the 23rd 33, III indicated a disagreeable/negative intent to the 13th 31 and the 23rd 33, and JJJ indicated a disagreeable/negative intent to the 15th 32. The electronic device 100 may apply a positive weight value to the 23rd 33 based on the positive/agreeable intent of HHH, and apply negative weight values to the 13th 31, the 15th 32, and the 23rd 33 based on the disagreeable/negative intents of III and JJJ. With respect to the slot content of the location slot, GGG indicated a disagreeable/negative intent to Misa Hangang River Park 42, HHH and JJJ indicated positive/agreeable intents to the sports center 43, and III indicated a positive/agreeable intent to the sports grounds 41 and Misa Hangang River Park 42. The electronic device 100 may apply a negative weight value to Misa Hangang River Park 42 based on the disagreeable/negative intent of GGG, apply positive weight values to the sports center 43 based on the positive/agreeable intents of HHH and JJJ, and apply positive weight values to the company sports grounds 41 and Misa Hangang River Park 42 based on the positive/agreeable intent of III.

The electronic device 100 may set, because the final slot content has not been decided, a plurality of candidate slot contents in each of the day slot and the location slot. In addition, the electronic device 100 may apply, in the case of the day slot (or a time related slot), an additional positive weight value to a slot content of a future time closest with the current time. In addition, the electronic device 100 may apply, in the case of the location slot, a weight value to the slot content of the location based on the frequency of positivity or negativity regarding slot contents of locations based on history information, whether it is a registered location, a distance with a current position, or the like. For example, the electronic device 100 may apply positive weight values according to the frequency of positivity regarding the slot content of the location, negative weight values according to the frequency of negativity, and a positive weight value if it is a registered location. Further, the electronic device 100 may increase an absolute value of the negative weight value to the slot content of the location according to an extent the distance with the current position becomes further apart.

The electronic device 100 may output candidate slot contents from candidate slot contents with the highest weight value according to weight value information in a descending order. Alternatively, the electronic device 100 may add candidate slot contents together with the priority order to a calendar application, and the like based on weight value. In an embodiment, if the weight values of the slot contents of the day slot are in an order of the 13th 31, the 15th 32, the 23rd 33, and the 25th 34, the electronic device 100 may arrange and output the slot contents of the day slot according to the above-described order, or add the slot contents of the day slot together with the priority order information to the calendar application, and the like. In addition, if the weight values of the slot contents of the location slot are in an order of the sports center 43, Misa Hangang River Park 42, and the company sports grounds 41, the electronic device 100 may arrange and output slot contents of the location slot according to the above-described order or add slot contents of the location slot together with the priority order information to another application.

In the above, various embodiments of generating an event have been described. A control method of an electronic device generating an event will be described below.

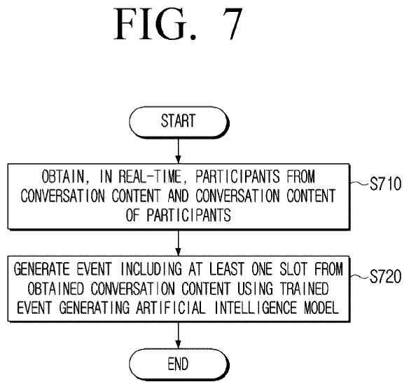

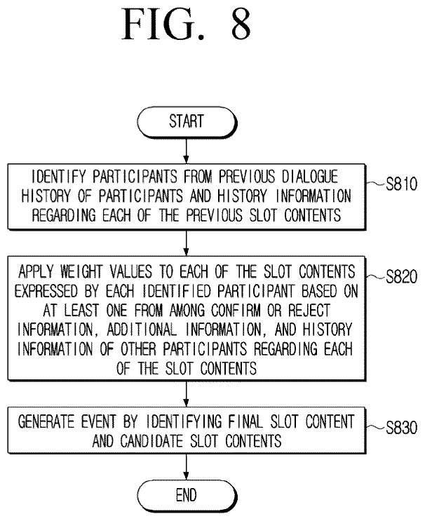

FIG. 7 is a flowchart illustrating a control method of an electronic device according to an embodiment of the disclosure, and FIG. 8 is a flowchart illustrating a detailed process of generating an event according to an embodiment of the disclosure. FIG. 7 and FIG. 8 will be described referencing both together.

Referring to FIG. 7, the electronic device may obtain, in real-time, participants from the conversation content and conversation content of the participants (S710). The electronic device may identify participants that participated in a dialogue. The electronic device may generate a separate database for each participant, and manage the conversation content expressed by each participant. The electronic device may determine the start area and the end area of the conversation content expressed by each participant and an extraction position of the slot content. The electronic device may determine the domain of the slot from the conversation content. The electronic device may generate a slot based on the determined domain, and add a corresponding slot by extracting the slot content included in the conversation content. The electronic device may identify whether there is agreement/positivity or disagreement/negativity regarding the slot content. Further, the electronic device may determine whether to add or delete the slot content, and decide on whether to maintain the existing slot content. The electronic device may generate an event including at least one slot from the obtained conversation content using the trained event generating artificial intelligence model (S720).

Specifically, referring to FIG. 8, the electronic device may identify participants from a previous dialogue history of participants and history information regarding each of the previous slot contents (S810). The electronic device may apply weight values to each of the slot contents expressed by each of the identified participants based on at least one from among confirm or reject information, additional information, and history information of other participants regarding each of the slot contents expressed by each participant identified from the obtained conversation content (S820).

For example, the electronic device may identify the decision maker from among the participants based on history information, and apply a positive weight value to the slot content agreed by the identified decision maker. Alternatively, the electronic device may apply an additional positive weight value corresponding to the number of positive responses of participants regarding the slot content to the slot content, and apply an additional negative weight value corresponding to the number of negative responses of participants regarding the slot content to the slot content. The electronic device may apply, based on the event included in the previous dialogue history being the same as the current event, a weight value to the slot content which is the same as the slot content of the event included in the previous dialogue history.

For example, the slot may include at least one from among time and a location. If the slot is a time slot, the electronic device may apply an additional positive weight value to a slot content of a future time closest with the current time. If the slot is a location slot, the electronic device may apply a weight value to the slot content of the location slot based on at least one from among the frequency of positivity regarding the slot content of the location based on the history information, the frequency of negativity regarding the slot content of the location based on the history information, whether it is a registered location, and a distance with the current position.

The electronic device may determine a slot content agreed by participants of a pre-set number or a slot content of greater than or equal to a pre-set weight value as the final slot content of the corresponding slot. Alternatively, the electronic device may generate an event by setting the candidate slot contents in slots with no final slot content decided based on the applied weight values (S830).

The electronic device may output the generated event information including at least one from among the final slot content and the candidate slot contents. For example, the electronic device may output the candidate slot contents from the candidate slot content with the highest weight value according to the weight value information of the candidate slot contents in a descending order.

The disclosure describes of generating an event by minimizing errors in the event information extracted from the conversation content. Effects described in the disclosure are not limited to the above-mentioned effects, and other effects not mentioned in the above may be clearly understood by one of ordinary skill in the art from the descriptions below.

The control method of the electronic device that generates an event according to the various embodiments described above may be provided in a computer program product. The computer program product may include an S/W program itself or a non-transitory computer-readable medium stored with the S/W program.

The non-transitory computer-readable medium may refer to a medium that stores data semi-permanently rather than storing data for a very short time, such as a register, a cache, memory, or the like, and is readable by the device. Specifically, the above-described various applications or programs may be provided stored in the non-transitory computer-readable medium such as, for example, and without limitation, a compact disc (CD), a digital versatile disc (DVD), a hard disc, a Blu-ray disc, a USB, a memory card, a ROM, and the like.

While example embodiments of the disclosure have been illustrated and described above, it will be understood that the disclosure is intended to be illustrative, not limiting. It will be understood by those skilled in the art that various changes in form and details may be made therein without departing from the true spirit and full scope of the disclosure, including the appended claims and their equivalents.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. A control method of an electronic device for generating an event, the method comprising:
obtaining, in real-time, participants from a conversation content and the conversation content of the participants; and
generating an event including at least one slot from the obtained conversation content using a trained event generating artificial intelligence model,
wherein the generating the event comprises:
identifying the participants and history information regarding slot contents from a dialogue history of the participants;
applying weight values to each of the slot contents expressed by each identified participant based on at least one among confirm or reject information, additional information, and history information of other participants regarding respective slot contents expressed by each participant identified from the obtained conversation content;
determining a slot content agreed by a pre-set number of participants, or a slot content having at least a pre-set weight value as a final slot content of the at least one slot of the event; and
generating the event by setting candidate slot contents, being at least some of the slot contents expressed by each identified participant, in slots with no final slot content based on the applied weight values.

2. The method of claim 1, wherein
the applying the weight values to the slot contents comprises:
identifying a decision maker among the participants based on the history information, and
applying a positive weight value to a slot content agreed by the identified decision maker.

3. The method of claim 1, wherein
the applying the weight values to the slot contents comprises:
applying a positive weight value corresponding to a number of positive responses of the other participants to the slot contents expressed by each identified participant, and
applying a negative weight value corresponding to a number of negative responses of the other participants to the slot contents expressed by each identified participant.

4. The method of claim 1, wherein
the applying the weight values to the slot contents comprises:
applying, based on an event included in the dialogue history being similar to a current event, a weight value to a slot content which is similar to a slot content of the event included in the dialogue history.

5. The method of claim 1, wherein
the at least one slot includes at least one among a time or a location.

6. The method of claim 5, wherein
the applying the weight values to the slot contents comprises:
applying, based on the at least one slot being a time slot, a positive weight value to a slot content of a future time closest with a current time.

7. The method of claim 5, wherein
the applying the weight values to the slot contents comprises:
applying, based on the at least one slot being a location slot, a weight value to a slot content of the location slot based on at least one among a frequency of positivity regarding a slot content of a location based on the history information, a frequency of negativity regarding a slot content of a location based on the history information, whether the location is a registered location, or a distance with a current position.

8. The method of claim 1, further comprising:
outputting the generated event information including at least one among the final slot content and the candidate slot contents.

9. The method of claim 8, wherein
the outputting the event information comprises:
outputting the candidate slot contents from a candidate slot content with a highest weight value according to weight value information of the candidate slot contents in a descending order.

10. An electronic device, comprising:
an input interface;
a communication interface;
a memory storing instructions; and
at least one processor configured to execute the instructions,
wherein, by executing the instructions, the at least one processor is configured to:
obtain, in real-time, participants from a conversation content and the conversation content of the participants through the input interface and the communication interface, and
generate an event comprising at least one slot from the obtained conversation content using a trained event generating artificial intelligence model, and
wherein the at least one processor is configured to:
identify the participants and history information regarding slot contents from a dialogue history of the participants stored in the memory,
apply weight values to each of the slot contents expressed by each identified participant based on at least one among confirm or reject information, additional information, and history information of other participants regarding each of the slot contents expressed by each participant identified from the obtained conversation content,
determine a slot content agreed by a pre-set number of participants, or a slot content having at least a pre-set weight value as a final slot content of the at least one slot of the event, and
generate the event by setting candidate slot contents, being at least some of the slot contents expressed by each identified participant, in slots with no final slot content based on the applied weight values.

11. The electronic device of claim 10, wherein
the at least one processor is further configured to:
identify a decision maker among the participants based on the history information using the trained event generating artificial intelligence model, and
apply a positive weight value to a slot content agreed by the identified decision maker.

12. The electronic device of claim 10, wherein
the at least one processor is further configured to:
apply a positive weight value corresponding to a number of positive responses of the other participants to the slot contents expressed by each identified participant using the trained event generating artificial intelligence model, and
apply a negative weight value corresponding to a number of negative responses of the other participants to the slot contents expressed by each identified participant.

13. The electronic device of claim 10, wherein
the at least one processor is further configured to:
apply, based on an event comprised in the dialogue history being identified as similar to a current event by using the trained event generating artificial intelligence model, a weight value to a slot content which is similar to the slot content of the event comprised in the dialogue history.

14. The electronic device of claim 10, wherein
the at least one slot comprises at least one among a time or a location.

15. The electronic device of claim 14, wherein
the at least one processor is further configured to:
apply, based on the at least one slot being identified as a time slot by using the trained event generating artificial intelligence model, a positive weight value to a slot content of a future time closest with a current time.
